(19) United States
(12) Patent Application Publication
(10) Pub. No.: US 2024/0198544 A1
(43) Pub. Date: Jun. 20, 2024

(54) UTILITY KNIFE BLADE WITH FUNCTIONAL CUTOUTS

(71) Applicant: Stanley Black & Decker, Inc., New Britain, CT (US)

(72) Inventors: Cole Thomas Sanders, Higganum, CT (US); Gregory Tropea, Berlin, CT (US); Sotir Moliko, Avon, CT (US)

(21) Appl. No.: 18/081,309

(22) Filed: Dec. 14, 2022

(51) Int. Cl. B26B 9/00; B26B 5/00

(52) U.S. Cl. CPC B26B 9/00; B26B 5/001

(57) ABSTRACT

A utility knife blade may include a planar body generally shaped as an isosceles trapezoid with a long base, a short base, a first leg, and a second leg, the long and short base being generally parallel; a sharpened edge formed on the long base; an engagement feature configured to retain the utility knife blade in a utility knife; and a first functional cutout extending into the first leg, spaced from both the engagement feature and the sharpened edge. A utility knife blade may also include a planar body defining an unsharpened edge and a sharpened edge; an engagement feature configured to retain the utility knife blade in a utility knife; and a first functional cutout extending into the planar body. The planar body is configured to bend without breaking upon application of a force transverse to the planar body that exceeds an intended force for the first functional cutout.

### FIELD OF THE INVENTION

The present invention relates generally to hand tools, and more particularly, knives, and blades for the same.

### BACKGROUND OF THE INVENTION

Utility knives are often configured to house a replaceable blade which may be replaced after extensive use. Some conventional utility knife blades are trapezoidal and are configured so that one side of the blade may be used, while the other side of the blade is held within the housing, fixing the blade relative to the housing. In some such blades, when it is desirable to replace the blade, the blade may be rotated in the blade holder assembly, so that the side of the trapezoid previously used (and presumably dulled through use) is held within the housing, while the side of the trapezoid previously retained within the housing may be selectively exposed for use. In some blades, perforations are formed in the blade so that a portion of the blade may be snapped off to expose a new cutting surface (e.g., when the blade is further extended out from the utility knife). When desired (e.g., once both sides of the trapezoidal blade are thoroughly used, or when a last blade segment is used) the previous blade may be discarded, and a new blade may be inserted into the housing.

Among other things, the present application relates to improvements for such replaceable utility blades.

### SUMMARY OF THE INVENTION

According to one aspect of this disclosure, a utility knife blade includes a planar body generally shaped as an isosceles trapezoid with a long base, a short base, a first leg, and a second leg, the long base being generally parallel to the short base; a sharpened edge formed on the long base; an engagement feature configured to retain the utility knife blade in a utility knife; and a first functional cutout extending into the first leg, spaced from both the engagement feature and the sharpened edge.

According to another aspect of this disclosure, a utility knife blade includes a planar body defining an unsharpened edge and a sharpened edge; an engagement feature configured to retain the utility knife blade in a utility knife; and a first functional cutout extending into the planar body. The planar body is configured to bend without breaking upon application of a force transverse to the planar body that exceeds an intended force for the first functional cutout.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

Features of utility knives in accordance with one or more embodiments are shown in the drawings, in which like reference numerals designate like elements. The drawings form part of this original disclosure in which:

FIG. 1 illustrates a side view of a utility knife blade having a functional cutout according to a first embodiment of the present disclosure;

FIG. 2 illustrates a side view of a utility knife blade having a plurality of functional cutouts according to a second embodiment of the present disclosure;

FIG. 3 illustrates a side view of a utility knife blade having a functional cutout and scoring to create additional functional cutouts according to a third embodiment of the present disclosure; and

FIGS. 4A-E illustrate side, top, bottom, front, and rear views respectively of an ornamental configuration of a utility knife blade of the present disclosure, labeled to indicate ornamental features that may be claimed or disclaimed as further described herein.

### DETAILED DESCRIPTION OF THE ILLUSTRATED EMBODIMENT(S)

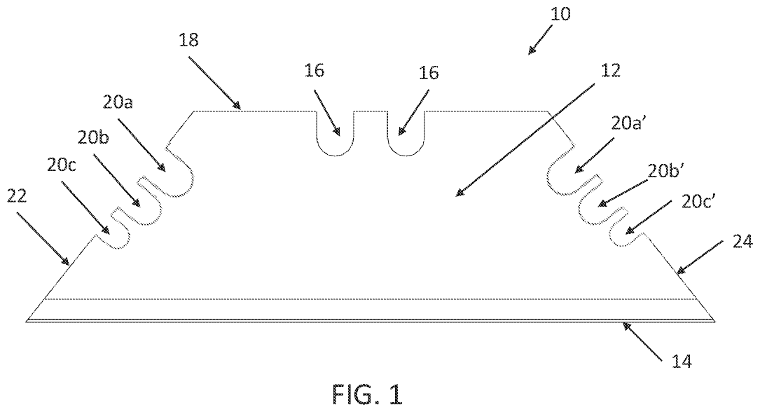

FIG. 1 shows an embodiment of a utility knife blade 10 of the present disclosure. As shown, the blade 10 has a planar body 12 and a sharpened edge 14. As further shown, the blade 10 includes an engagement feature 16 (e.g., a mounting feature) configured to permit retention of the blade 10 in a utility knife (not shown) by having a blade retention portion of the knife engage, be received in or mount into the engagement feature 16. Such utility knives could include those disclosed in U.S. Pat. No. 8,567,071, incorporated herein by reference in its entirety, as nonlimiting examples. As shown in the illustrated embodiment, the blade 10 may include a pair of engagement features 16 formed in an opposing edge 18 opposite the sharpened edge 14. In other embodiments a single engagement feature 16 may be utilized, while in still other embodiments one or more engagement feature 16 may be formed to an interior of the planar body 12, between the sharpened edge 14 and the opposing edge 18.

As additionally shown in FIG. 1, in some embodiments, the utility knife blade 10 may include a functional cutout 20a formed on an intermediate edge 22 between the sharpened edge 14 and the opposing edge 18. In some embodiments, such as that illustrated, the utility knife blade 10 may include a second functional cutout 20b, and in still other embodiments, may include a third functional cutout 20c. Additional functional cutouts 20 (e.g., functional cutouts 20a′, 20b′ and 20c′) may be formed on an opposing intermediate edge 24, opposite the intermediate edge 22. In some embodiments functional cutouts 20′ (e.g., functional cutouts 20a′, 20b′ and 20c′) may mirror the functional cutouts 20a, 20b, and 20c.

As shown, in some embodiments the blade 10 may be formed as a generally isosceles trapezoidal shape. As such, the sharpened edge 14 may form a long base of the trapezoidal shape while the opposing edge 18 may form a short base, the sharpened edge 14 and the opposing edge 18 being generally parallel to each other. It may be appreciated that the sharpened edge 14 may be sharpened in intricate ways, such as to form a hook blade with a sharpened hook region, as long as the general extent of the sharpened edge 14 is generally parallel to the opposing edge 18 in such embodiments and the overall impression is that of an isosceles trapezoid in such embodiments. The intermediate edge 22 and the opposing intermediate edge 24 may thus be understood as the first and second legs of the isosceles trapezoid shape of the planar body, with the functional cutouts 20 extending into either leg, spaced from both the engagement feature 16 and the sharpened edge 14. In some embodiments, such as where the engagement feature 16 extends into the opposing edge 18, the functional cutouts 20 may be understood as being spaced from the opposing edge 18. In other embodiments, such as where the engagement feature 16 is formed to an interior of the

[symbol]

In embodiments including multiple functional cutouts 20, the functional cutouts 20a, 20b, 20c, or so on may be of the same size, or as illustrated, may be of differing sizes. For example, as shown in the illustrated embodiment, the functional cutout 20a is larger than the functional cutout 20b, which is larger than the functional cutout 20c. In some embodiments, one or more of the functional cutouts may be configured as wire strippers. As such, the first functional cutout 20a may be sized to strip insulation from an 8-gauge wire while the second functional cutout 20b may be sized to strip insulation from a 12-gauge wire and the third functional cutout 20c may be sized to strip insulation from a 14-gauge wire. In some embodiments, the first functional cutout 20a may be sized to strip a common gauge of wire (e.g., one of 6, 8, 10, 12 or 14 gauge) while the second functional cutout 20b may be sized to strip another common gauge of wire different from the first common gauge of wire (e.g., another one of 6, 8, 10, 12, or 14 gauge).

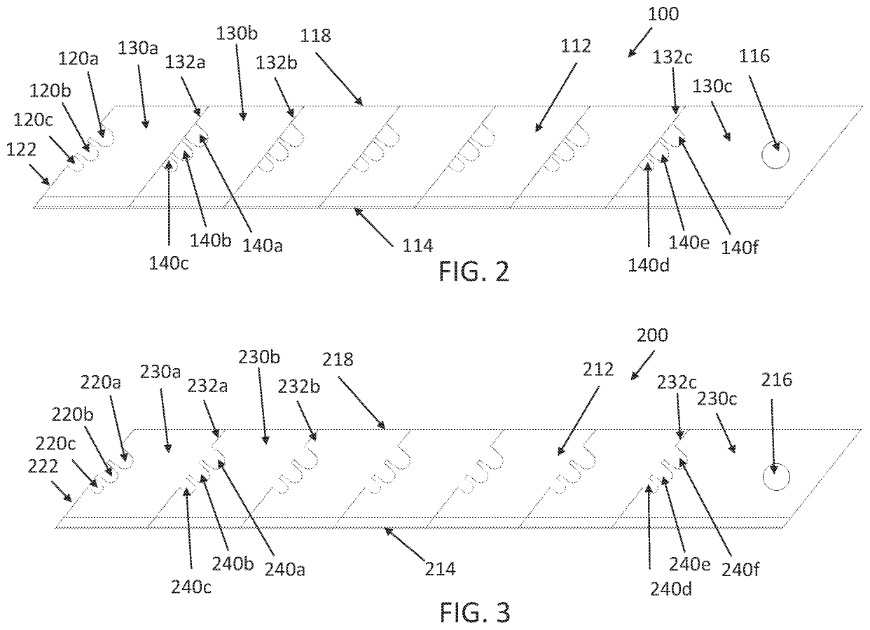

FIG. 2 illustrates another embodiment of a utility knife blade of the present disclosure. As shown, the utility knife blade 100 may be configured as a “snap-knife” blade configured for use in a “snap knife” utility knife, such as those disclosed in U.S. Pat. No. 4,233,734, incorporated herein by reference in its entirety. The blade 100 may be configured with a planar body 112, which may generally have the shape of a parallelogram in some embodiments, and includes a sharpened edge 114. The blade 100 includes an engagement feature 116 in the illustrated embodiment, which as shown may be formed as an aperture in the planar body 112. In such snap knife blades, the blade 100 may be slid relative to a housing of the knife (e.g., pushed through a slider engaging the engagement feature 116) so that the blade 100 can extend as desired from the knife. As shown, an opposing edge 118 may be generally parallel to the sharpened edge 114. Similar to the blade 10, one or more functional cutouts 120 (e.g., functional cutouts 120a, 120b, and 120c, akin to functional cut outs 20 in the blade 10) may be formed on an intermediate edge 122, between the sharpened edge 114 and the opposing edge 118.

It is a feature of snap knife blades such as blade 100 to include a plurality of segments 130 formed in the planar body 112, which may be snapped relative to one another to detach a used portion of the sharpened edge 114 and expose a new surface of the sharpened edge 114 associated with a subsequent segment 130. In the illustrated embodiment, a first segment 130a is connected by seam 132a to a second segment 130b. Additional segments may be provided in various embodiments, e.g., connected by a second seam 132b. A terminal seam, e.g., seam 132c, may connect to a terminal segment 130c, which may carry the engagement feature 116 thereon. As shown the illustrated embodiment, formed in the planar body 112, adjacent to the seams 132a, 132b, 132c, and other intermediate seams, are interior segment functional cutouts 140 (e.g., functional cutouts 140a, 140b, and 140c between segment 130a and 130b, and functional cutouts 140d, 140e, and 140f between a last detachable segment 132 and the terminal segment 130c, adjacent to the seam 132c). Accordingly, detachment of a segment 130 at a seam 132 may expose one or more interior segment functional cutouts 140, as earlier segments are discarded. It may be appreciated that the functional cutouts 120, the functional cutouts 140 and the engagement feature 116 may all be stamped from the planar body 112 in the same or similar process, while the seams 132 may be pressed into or perforate the planar body 112 so as to create a weaker point for desired separation upon application of sufficient force. In an embodiment, the remaining structure of the planar body 112 connecting the segments 130 at the seams 132 may be strong enough that a force to separate a forwardmost segment 130 (distal from the terminal segment 130c) from the remainder of the planar body 112 sufficiently exceeds an intended force applied by a user against the functional cutouts 120 and 140, so that unintentional separation or deformation of the segments 130 does not occur when using the functional cutouts 120 or 140 for their intended function (e.g., as a wire stripper to strip insulation from wire).

While in the embodiment of the blade 100 of FIG. 2 includes interior segment functional cutouts 140 that already exist in the blade 100, in some embodiments the segments may be shaped with an irregular shape seam to form the functional cutouts as a segment is detached. For example, as shown in FIG. 3, a snap knife blade 200 may be configured with a planar body 212 and include a sharpened edge 214. The blade 200 includes an engagement feature 216 in the illustrated embodiment, which as shown may be formed as an aperture in the planar body 212. As shown, an opposing edge 218 may be generally parallel to the sharpened edge 214. Similar to the blade 100, one or more functional cutouts 220 (e.g., functional cutouts 220a, 220b, and 220c, akin to functional cut outs 120 in the blade 100) may be formed on an intermediate edge 222, between the sharpened edge 214 and the opposing edge 218.

In the snap knife blade 200, a plurality of segments 230 are formed in the planar body 212, which may be snapped relative to one another to detach a used portion of the sharpened edge 214 and expose a new surface of the sharpened edge 214 associated with a subsequent segment 230. In the illustrated embodiment, a first segment 230a is connected by seam 232a to a second segment 230b. Additional segments may be provided in various embodiments, e.g., connected by a second seam 232b. A terminal seam, e.g., seam 232c, may connect to a terminal segment 230c, which may carry the engagement feature 216 thereon. As shown the illustrated embodiment, the seams 232a, 232b, 232c, and other intermediate seams are formed shaped so that detaching one of the segments 230 distal from the terminal segment 230c causes creation of interior segment functional cutouts 240 (e.g., functional cutouts 240a, 240b, and 240c when segment 230a is separated from segment 230b at seam 232a, and functional cutouts 240d, 240e, and 240f are created when a last detachable segment 232 is separated from the terminal segment 230c along the seam 232c. Accordingly, detachment of a segment 230 at a seam 232 cuts out and creates one or more interior segment functional cutouts 240, as earlier segments are discarded. It may be appreciated that the functional cutouts 220 and the engagement feature 216 may all be stamped from the planar body 212 in the same or similar process, fully punching through the planar body 212, while the seams 232 may be pressed into or perforate the planar body 212 so as to create a weaker point for desired separation upon application of sufficient force. As with the seams 132 of the knife 100, in an embodiment, the remaining structure of the planar body 212 connecting the segments 230 at the seams 232 may be strong enough that a force to separate a forwardmost segment 230 (distal from the terminal segment 230c) from the remainder of the planar body 212 sufficiently exceeds an intended force applied by a user against the functional cutouts 220 (or 240 when exposed), so that unintentional separation or deformation of the segments 230, e.g., at the seams 232, does not occur when using the functional cutouts 220 or 240 for their intended function (e.g., as a wire stripper to strip insulation from wire).

It may be appreciated that according to some embodiments, the planar bodies such as planar bodies 12, 112 or 212, or other similar embodiments, may be formed from a steel (e.g., a steel alloy) that is configured to bend upon exertion of a transverse force that would in other compositions or configurations cause the planar bodies 12, 112, 212 to break. For example, using the HR-30N hardness scale (hereinafter “HR-30N”), in an embodiment the planar bodies may be formed of any of numerous different grades of steel capable of being heat treated to a surface hardness less than approximately 75 HR-30N. In an embodiment, the hardness may be within the range of approximately 58 HR-30N to approximately 70 HR-30N, such as any of numerous different standard AISI grades, including 6135, 6150 and D6A. In some embodiments, the hardness of the planar bodies 12, 112, 212 may be approximately between 61-67 HR-30N, including approximately 65 HR-30N. Accordingly, when one or more of the functional cutouts 20, 120, 140, 220, 240, or so on are formed as a wire stripper, and a user pulls a wire against the function cutout to strip insulation from the wire, an excessive amount of applied force would be unlikely to cause a fracture of the planar body (e.g., from the functional cutout to one of the edges of the blade, or from one edge of the blade to another edge of the blade). In some embodiments, the material composition of the blades disclosed herein may be formed according to the disclosure of U.S. Pat. No. 7,658,129, incorporated by reference herein in its entirety.

As may be recognized by those skilled in the pertinent art based on the teachings herein, the currently preferred materials used to construct the planar body 12, 112, 212 disclosed herein are only exemplary, and numerous other types of metals that are currently or later become known for performing the functions of the planar body 12, 112, 212 may be equally employed to form utility knife blades in accordance with the present invention.

It may be appreciated that the components described herein may be of different constructions or configurations, including but not limited to one or more being comprised of different material choices. For example, the components described herein may each be constructed from a variety of materials, including but not limited to one or more plastics, metals, rubbers, elastomers, ceramics, or any other appropriate material choice. For example, in an embodiment the blades may be formed of aluminum (e.g., machined aluminum), iron (e.g., steel), or any other appropriate material, and may have appropriate coatings selectively applied thereon, including but not limited to carbide, for example.

It may also be appreciated that manufacture of blades such as blade 100 and blade 200 to including cutouts therein may vary. For example, in some embodiments multiple cutout features could be cutout together. As a non-limiting example, in some embodiments cutouts 140a, 140b, and 140c could be joined together as a single aperture, linked by an opening adjacent to the seam 132a, creating interconnected waste material being stamped out of the planar body 112. In some embodiments, to reduce wear to stamping dies, for instance, cutouts may avoid 90° angles, such that cutouts 140a, 140b, and 140c formed in 130b partially extend into 130a so as to not form a 90° intersection with the seam 132a, but instead form a non-functional (as to the finished product) aperture on segment 130a adjacent to the cutouts 140 on segment 130b. Such non-functional apertures for reducing wear to stamping dies may also be formed on connecting waste material when creating strips of isosceles trapezoid utility knife blades such as blade 100. As such, while the cutouts 120, 140, and so on shown in the illustrated embodiments have a D shape, it may be appreciated that other appropriate shapes may be utilized in other embodiments (e.g., an oval, ellipse, or stadium shape) which may partially be formed in waste product in some embodiments, or may be non-functional in finished products such as appearing adjacent to a snap seam opposite a working front of the blade.

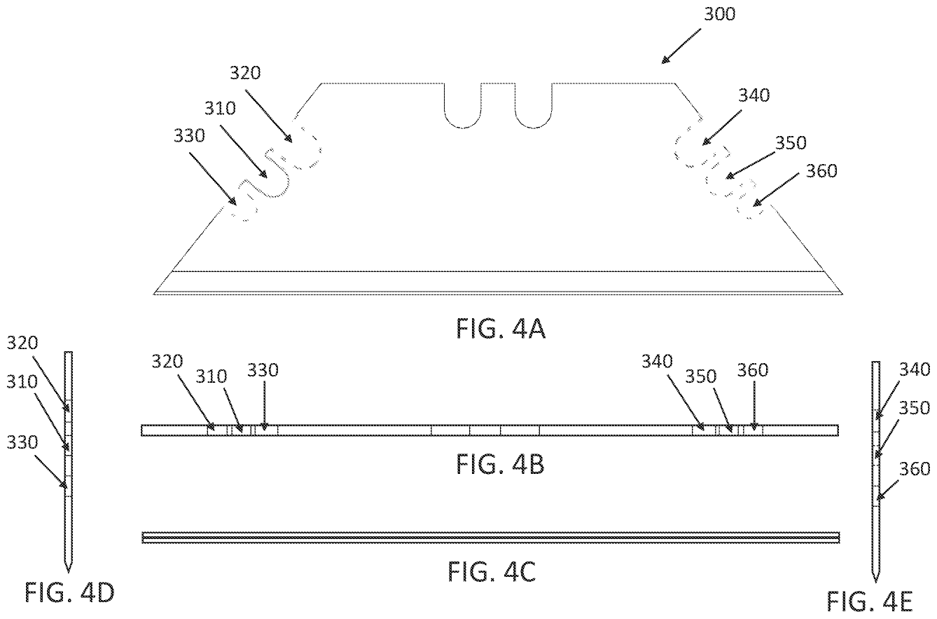

It may further be appreciated that beyond the structural and utility configuration, the ornamental appearance of utility knife blades may be separately appreciated and claimed in one or more continuation applications. For example, FIGS. 4A-4E illustrate various views of a utility knife blade 300. In particular, FIG. 4A shows a first side of the blade 300. An opposing side of the blade 300 is omitted, but would be understood as a mirror of the first side. FIG. 4B illustrates a top view, FIG. 4C illustrates a bottom view, FIG. 4D illustrates a front view, and FIG. 4E illustrates a rear view of the blade 30. As shown, the utility knife blade includes a cutout 310 as depicted in solid lines, extending into the front view of FIG. 4D. Additional cutouts 320, 330, 340, 350, and 360 are illustrated in dashed lines, and in a design patent application would be understood to be disclaimed. It may be appreciated that in other embodiments, any one or more of cutouts 320, 330, 340, 350, and 360 may be claimed, either while cutout 310 remains claimed or is itself disclaimed. Accordingly, it may be appreciated that from an ornamental perspective, modifications to the drawings in FIGS. 4A-4E through this disclosure may permit claiming of various related ornamental designs.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A utility knife blade comprising:
a planar body generally shaped as an isosceles trapezoid with a long base, a short base, a first leg, and a second leg, the long base being generally parallel to the short base;
a sharpened edge formed on the long base;
an engagement feature configured to retain the utility knife blade in a utility knife; and
a first functional cutout extending into the first leg, spaced from both the engagement feature and the sharpened edge.

2. The utility knife blade of claim 1, wherein the engagement feature is formed extending into the short base.

3. The utility knife blade of claim 1, further comprising a second functional cutout extending into the first leg, spaced from the engagement feature, the sharpened edge, and the first functional cutout.

4. The utility knife blade of claim 3, wherein the first functional cutout is a first wire stripper and the second functional cutout is a second wire stripper, and the first wire stripper is sized for a larger gauge wire than the second wire stripper.

5. The utility knife blade of claim 1, further comprising a second functional cutout extending into the second leg, spaced from the engagement feature and the sharpened edge.

6. The utility knife blade of claim 5, wherein the first functional cutout is a first wire stripper and the second functional cutout is a second wire stripper, and the first wire stripper is sized for a larger gauge wire than the second wire stripper.

7. The utility knife blade of claim 1, wherein the planar body is configured to bend without breaking upon application of a force transverse to the planar body that exceeds an intended force for the first functional cutout.

8. The utility knife blade of claim 1, wherein the first functional cutout is a first wire stripper.

9. The utility knife blade of claim 1, wherein the planar body comprises a surface hardness of less than approximately 75 HR-30N.

10. The utility knife blade of claim 9, wherein the planar body comprises a surface hardness of approximately between 61-67 HR-30N.

11. A utility knife blade comprising:
a planar body defining an unsharpened edge and a sharpened edge;
an engagement feature configured to retain the utility knife blade in a utility knife; and
a first functional cutout extending into the planar body;
wherein the planar body is configured to bend without breaking upon application of a force transverse to the planar body that exceeds an intended force for the first functional cutout.

12. The utility knife blade of claim 11, wherein the engagement feature is formed extending into the unsharpened edge.

13. The utility knife of claim 11, wherein the first functional cutout is a wire stripper.

14. The utility knife of claim 11, further comprising a second functional cutout extending into the planar body, spaced from the engagement feature, the sharpened edge, and the first functional cutout.

15. The utility knife of claim 14, wherein the first functional cutout is a first wire stripper and the second functional cutout is a second wire stripper.

16. The utility knife blade of claim 11, wherein the planar body is generally shaped as an isosceles trapezoid with a long base, a short base, a first leg, and a second leg, the long base being generally parallel to the short base.

17. The utility knife of claim 16, wherein the engagement feature is formed extending into the short base.

18. The utility knife of claim 16, wherein the first functional cutout extends into the first leg.

19. The utility knife blade of claim 18, further comprising a second functional cutout extending into the second leg, spaced from the engagement feature and the sharpened edge.

20. The utility knife blade of claim 11, wherein the planar body comprises a surface hardness of less than approximately 75 HR-30N.
